(19) United States
(12) Patent Application Publication
(10) Pub. No.: US 2010/0140970 A1
(43) Pub. Date: Jun. 10, 2010

(54) Support means for assisting in hauling an item

(76) Inventor: John VRYNOIS, Unley (AU)

Correspondence Address: COLEMAN SUDOL SAPONE, P.C., 714 COLORADO AVENUE, BRIDGE PORT, CT, 06605-1601, US

(21) Appl. No.: 12/587,497

(22) Filed: Oct. 7, 2009

(30) Foreign Application Priority Data
Oct. 9, 2008 (AU) 2008905255

(51) Int. Cl. B65G 7/12

(52) U.S. Cl. 294/152

(57) ABSTRACT

In one aspect the present invention relates to a load carrying apparatus including, two adjacent support members, said support members having respective first and second end portions and connected, in a spaced apart configuration, at a middle part by a cross member, the cross member being positionable under an object to be carried such that the end portions extend outwardly from under opposing sides of the object, wherein the first and second end portions including limb engaging bands for engagement with an arm or hand of a user. In one embodiment the apparatus includes locating means that act to both secure the limb engaging bands in place for easy grasping by the user, but to also protect the object during transport. In this way the apparatus can be secured to object and left in place during transport of the object in, for instance, a removalist truck.

### FIELD OF THE INVENTION

The present invention relates to an apparatus and method for hauling an item using a load carrying apparatus. In one particular aspect the invention relates to a support strap apparatus that assists in manually hauling a large piece of furniture or a whitegoods item, such as a refrigerator.

### BACKGROUND OF THE INVENTION

There are various apparatus used to assist in the manual transportation of large heavy objects such as furniture or whitegoods including refrigerators by removalists and the like.

The simplest form is a length of rope or strap that is tied in a loop and positioned under a portion of the object. The user then supports at least some of the load by passing the loop around their neck or over one shoulder.

Other apparatus used in transporting heavy objects include hand trucks that include at least two wheels, a base plate and a handle typically perpendicular to the base plate. The object is positioned on the base plate and the handle is used to incline the object rearwardly so that it is supported on the wheels. The user is then able the move the object by pushing or pulling the hand truck. The object is however inclined and therefore the corners may damage walls or other furniture in the vicinity if the removalist is not particularly careful.

Another common apparatus is the dolly platform that includes a typically flat platform and four wheels positioned adjacent to the corners. The dolly is positioned under the object, which is then adjusted so that it rests on the platform. One of the problems with this type of dolly is that it is not suited to undulating or irregular surfaces. Furthermore the dolly cannot be used to move a piece of furniture down a flight of stairs unless it is tied or mounted to the object in some way.

Often when an object, such as a refrigerator, is being moved down a set of stairs it is placed on the landing. One person positions themselves on the downward side of the refrigerator and the other person positions themselves at the top of the stairs. The refrigerator is then tilting towards to person at the top of the stairs and the refrigerator is moved down the flight of stair at an inclined angle.

One difficulty is that many modern townhouses include narrow stairwells with several turns or corners. Furthermore the design of many town houses means that the kitchen is located on the upper floor. It is therefore a difficult and a time-consuming process to move large items such as refrigerators down the stairwell. One of the reasons for this is that the refrigerator must be righted at every corner to be able to negotiate the corners and the users have to reposition themselves appropriately. This repositioning also means that the likelihood of accidents occurring in increased.

It should be appreciated that any discussion of the prior art throughout the specification is included solely for the purpose of providing a context for the present invention and should in no way be considered as an admission that such prior art was widely known or formed part of the common general knowledge in the field as it existed before the priority date of the application.

### SUMMARY OF THE INVENTION

In a first aspect of the invention, but not necessarily the broadest or only aspect, there is proposed a load carrying apparatus including, two adjacent support members, said support members having respective first and second end portions and connected, in a spaced apart configuration, at a middle part by a cross member, the cross member being positionable under an object to be carried whereby said end portions extend outwardly from under opposing sides of the object, wherein the first and second end portions including limb engaging bands for engagement with an arm or hand of a user.

In one form secondary limb engaging bands for engagement with an arm or hand of a user are attached to respective support members at a middle part between, at least, one of the end portions and the cross member, whereby, in use, the load carrying apparatus is suspended between two users to assist in carrying said object in an upright position when the users are vertically displaced.

The support members may include a first set of limb engaging bands at respective first and second end portions. The first set of limb engaging bands includes at least two arms engaging bands attached to the support member in a longitudinally spaced apart configuration. In this way, users of different heights can use the apparatus by selecting an appropriate arm engage band.

The support members may include a second set of limb engaging bands at a middle part between, at least, one of the end portions and the cross member. The second set of limb engaging bands includes at least two limb engaging bands attached to the support member in a longitudinally spaced apart configuration. In this way, users of different heights can use the apparatus by selecting an appropriate limb engage band when the users are vertically displaced.

In another alternate form each support member includes two parallel elongate straps. Each of the parallel straps are attached to the cross member at a respective middle point. The first and second set of limb engaging bands are attached to and extend between the two parallel elongate straps of corresponding support members.

Accordingly, in use, a user inserts one of their arms between the adjacent elongate straps to engage with a selected limb engaging band. The users other arm is inserted between the elongate straps of the other support member. The user positioned on the other side of the object likewise positions their arms so that they engage with selected bands. The users then lift their forearms to therefore raise the object off the ground and in this posture the users move the object. The reader will appreciate that the push/pull method of lifting an object can be used, wherein the user engages their arms with a selected band and then pushes the object away from their body to provide greater clearance from the ground and their feet.

In a situation where the users will be vertically displaced, such as when they are moving the object down a flight of stairs a first user positions their arms to engage with the first set of limb engaging bands. The second user positioned on the other side of the object positions their arms to engage with the second set of limb engaging bands. In this way the object can be carried down the stairs in an upright position.

The limb engaging bands may be shaped to conform to the forearm of a user or be shaped for grasping by the hands of the user. In one form the bands are elastic, alternatively the strap are crescent shaped. In another form one side of the band extends outwardly from the plane of the respective support member to a greater degree than the opposing side. In one form when the forearm is inserted between the straps of the support member the band conforms to the forearm such that the edge of the band does not cut into the arm of the user.

In yet another form the cross member includes at least two straps extending between and attached to the middle part of said support members. The straps may be sewn to the support members by way of stitching or any other appropriate fixing means. The configuration of the apparatus when laid flat is therefore a H-shape.

In still another form the cross member is webbing that extends between the two support members. This webbing may include an elastic portion or alternately be a semi-rigid plate.

The cross member may be adjustable such that the distance between the parallel support members can be adjusted. This may be useful if the apparatus is being used to carry both large and small object. For instance the apparatus could be used on both a large double door refrigerator as well as a single narrow refrigerator. Alternatively the cross member could be removably attached to the support member such that the apparatus can be used in various configurations.

The cross member may be positioned under the object to be carried and therefore may include padding or a wear-resistant surface. The cross member may be connected to a securing means for fixing the cross member to the object. This may include hooks or a slip resistant material such as rubber that ensures the object does not move relative to the cross member while the apparatus is in use. In one form the securing means may include a strap that is attached to opposing sides of the cross member and is configured to extend up opposing sides of the object and be secured across the top surface.

The securing means may be in the form of a nylon strap that includes a hook and loop fastener. In this form one free end of the nylon strap includes the hook portion of the fastener and the other free end includes the loop portion of the fastener. In use the free ends are lifted up opposing sides of the object and joined at on the top surface by connecting the fastener portions. This therefore locks the apparatus to the object and prevents the object moving with respect to the apparatus.

A second set of limb engaging bands may be positioned between the middle part and each end of said support members. In this way either user can utilise the second set of bands to facilitate the movement of the article.

The straps, bands and cross member may all be constructed from nylon, polyester or polypropylene strapping. It should however be appreciated that other types of material could be used without departing from the spirit and scope of the invention.

The support member may include additional handles adjacent the cross member that can be used when the users are positioning the object at the top of a flight of stairs. The handle can be used by the user, who is going to walk backwards down the stair, to position the object in an appropriate position so they are able to use the second set of limb engaging bands. The handle can also be used to manoeuvre or support the object during transport.

In a second aspect of the invention there is proposed a load carrying apparatus including, two longitudinally extending support members, having respective first and second end portions with a plurality of graspable handles, the support members attached, in a spaced apart configuration, at a middle part, by a cross member, said support members affixed to respective generally planar locating means, the cross member positionable under an object to be carried, whereby opposing ends of said support members extend outwardly from under opposing sides of the object and secured by fastening means connected to the locating means, wherein the respective first and second end portions are held adjacent opposing side of the object.

In one form of preceding second aspect of invention the handles are grouped together along the support members and graspable with either the left or right hands of a users. There may be two groups of handles, one positioned at the extremity first and second end portions and another group positioned towards the middle part of the locating means. In this way the users, who are positioned on opposing sides of the object, can select a handle that enable them to lift and carry the object.

The generally planar locating means may be a sheet of material or webbing. The locating means can be constructed from the same material that removalist blankets are traditional made from. It should be appreciated that any suitable material could be used such as cotton, felt or polyester.

As can be appreciated if the object is being carried down a flight of stairs the user that is descending the stairs first will be vertically at a lower level than the object or the other user. Accordingly they will typically be required to grasp a handle at a position lower than the user that is following down the stairs.

Each group of handles may include three handles for each of the right and left hands that are positioned at different heights. This means that users of various heights can select a handle that is both suitable for their particular height requirement and for the application, such as flat surface or steps.

The handle may be in the form of straps that can be grasped by the user. The handles can be formed by stitching a series of bands between the support members and the locating means.

In another form of the preceding second aspect of invention, reversibly engagable intermediate pads may be provided to cushion the hands of the user when grasping the handles. These pads may be U-shaped and could be reversible engagable with a selected handle by way of a clip or hook. In a preferred form the pads have a curved outer surface and a downwardly extending slot. The slot may include a depending lip along an upper surface of the slot. In this way the user can fit the pad over the strap from the underside of the strap and grasp the pad to lift the object. The pad is prevented from disengaging with the strap by way of the depending lip. The user can remove the pad from the handle by disengaging the depending lip. The pad can then be used on a different handle or stored for future use.

One purpose of the locating means is to locate and maintain the position of the support members when the users are not grasping the handles, such as when they are resting or manoeuvring the object around a corner. Another purpose of the locating means is to protect the outer surface of the object during transport. The apparatus can be secured to the object to provide padding so that other objects can be stored on top of and adjacent the object without damage occurring.

Forearm engaging straps may be provided, the straps configured to be reversibly attached to the handles. In this way the user can attached a forearm engaging strap at a position on the apparatus that allows then the engage an arm to assist in the movement of the object. In a preferred form the forearm engaging strap is attached to a spacer that maintains the strap in a general open arrangement so prevent pinching of the arm of the user.

In a third aspect of the invention there is proposed a method of carrying an object with a load carrying apparatus including the steps of:
providing a load carrying apparatus having two adjacent support members having respective first and second end portions and connected in a spaced apart configuration at a middle part by a cross member, the cross member being positioned under an object to be carried such that, in use, the end portions extend outwardly from under opposing sides of the object, each of said first and second end portions including a limb engaging bands for engagement with an arm or hand of a user;
positioning a first user on a side of the object, wherein the user engages their arm or grasps with their hand the limb engaging bands of the first end portion;
positioning a second user on an opposing side of the object, wherein the user engages their arm or grasps with their hand the limb engaging bands of the second end portion; and
lifting said object using the load carrying apparatus such that the object can be carried across a surface.

### BRIEF DESCRIPTION OF THE DRAWINGS

The accompanying drawings, which are incorporated in and constitute a part of this specification, illustrate implementations of the invention and, together with the description and claims, serve to explain the advantages and principles of the invention. In the drawings:

FIG. 1 is a perspective view of a first embodiment of the load carrying apparatus of the present invention;

FIG. 2 is a perspective view of the load carrying apparatus of FIG. 1 in use;

FIG. 3 is a perspective view the load carrying apparatus of FIG. 1 being used to haul a refrigerator down a flight of stairs;

FIG. 4 is a perspective view of a second embodiment of the load carrying apparatus;

FIG. 5 is a perspective view of a third embodiment of the load carrying apparatus;

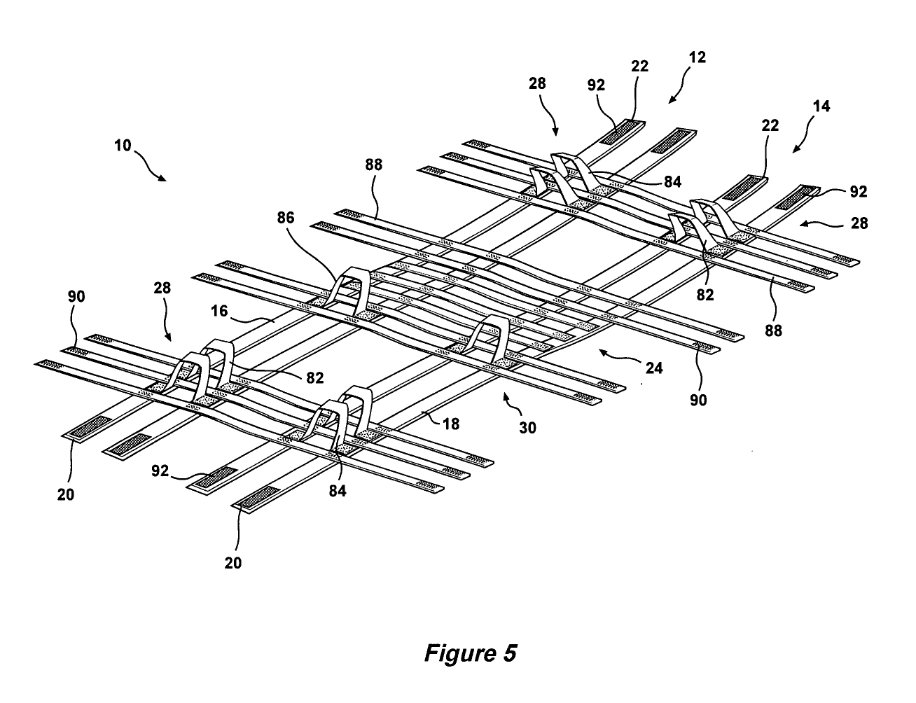

FIG. 6 is perspective view of a fourth embodiment of the load carrying apparatus;

FIG. 7 is a perspective view of the load carrying apparatus of FIG. 6 attached to a refrigerator;

FIG. 8 is a side view of the load carrying apparatus of FIG. 6 in use;

FIG. 9 is an enlarged perspective view of the load carrying apparatus of FIG. 6 illustrating removable hand engaging members; and

FIG. 10 is perspective view of a fifth embodiment of the load carrying apparatus.

### DETAILED DESCRIPTION OF THE ILLUSTRATED AND EXEMPLIFIED EMBODIMENTS

Similar reference characters indicate corresponding parts throughout the drawings. Dimensions of certain parts shown in the drawings may have been modified and/or exaggerated for the purposes of clarity or illustration.

Referring to the drawings for a more detailed description, a load carrying apparatus 10 is illustrated, demonstrating by way of examples arrangements in which the principles of the present invention may be employed. The load carrying apparatus 10 illustrated in the figures includes parallel support members 12, 14, each comprising elongate straps 16, 18, the support members 12, 14 having respective end portions 20, 22 and joined at a midpoint by a cross member 26, the cross member 26 being positioned under an object to be carried such that the end portions 20 and 22 extend outwardly for under opposing sides of the object, each of said end portions 20, 22 including a first set of limb engaging bands 28 for selective engagement with an arm or hand of a user, and a second set of limb engaging bands 30 being located between midpoint 24 and end portions 22 of respective support members 12, 14, whereby the load carrying apparatus 10 is suspended between two users to assist in carrying the object in an upright position when the users are vertically displaced.

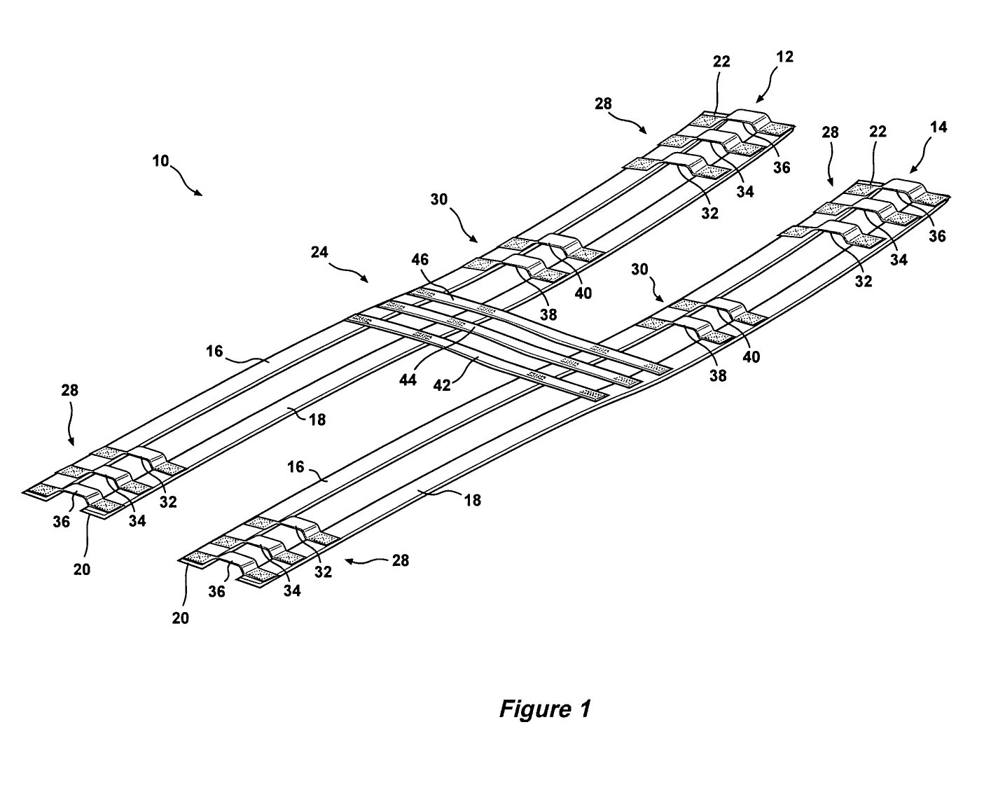

In a first embodiment, as illustrated in FIG. 1, the first sets of limb engaging bands 28 include three individual bands 32, 34, 36 for selective engagement with an arm of a user. The second sets of limb engaging bands 30 include two individual bands 38 and 40. Each of the two users can select the appropriate band depending upon their height or their relative position to other user. For instance a tall user may select band 36 to assist in supporting the object being moved while a shorter user may select band 32.

In a situation when the object is being moved down a flight of stairs the user positioned on the downward side would select either bands 38 or 40 while the user on the opposing side would select from bands 32 to 36.

As further illustrated in FIG. 1, the cross member 26 of the present embodiment includes three straps 42, 44, 46, extending between the midpoint 24 of the support members 12, 14. The straps 42, 44, 46 are attached to the respective elongate straps 16, 18 by way of nylon or cotton stitching. It should however be appreciated by the reader that the straps 42, 44, 46 may be removably attached to the support members 12, 14.

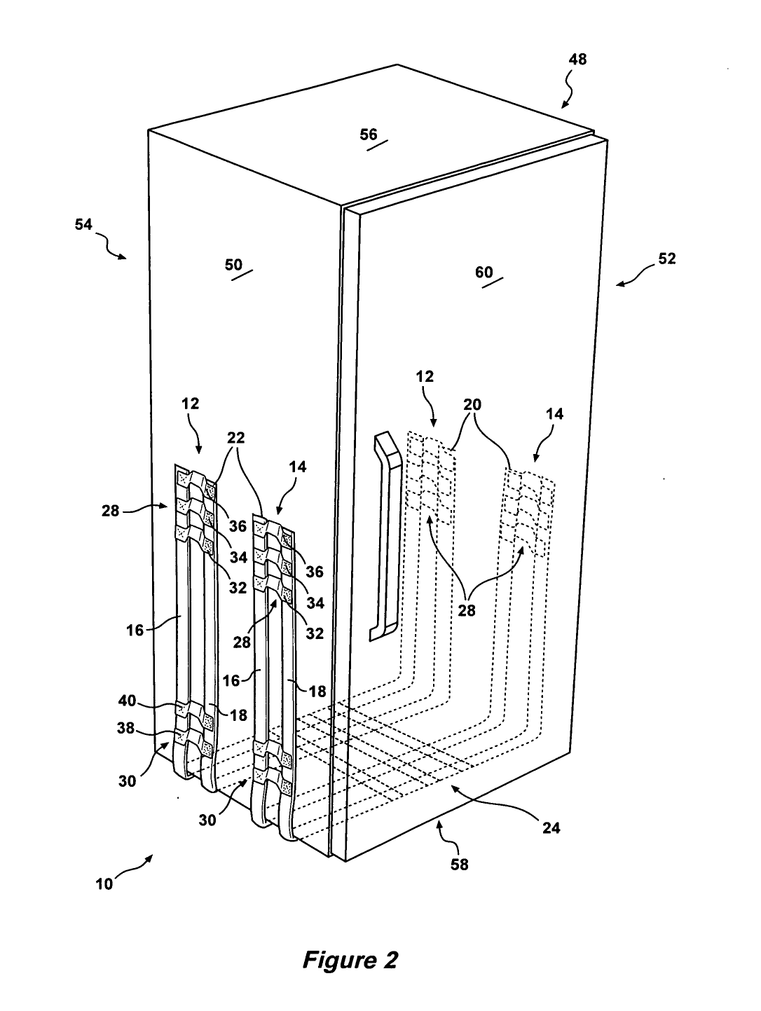

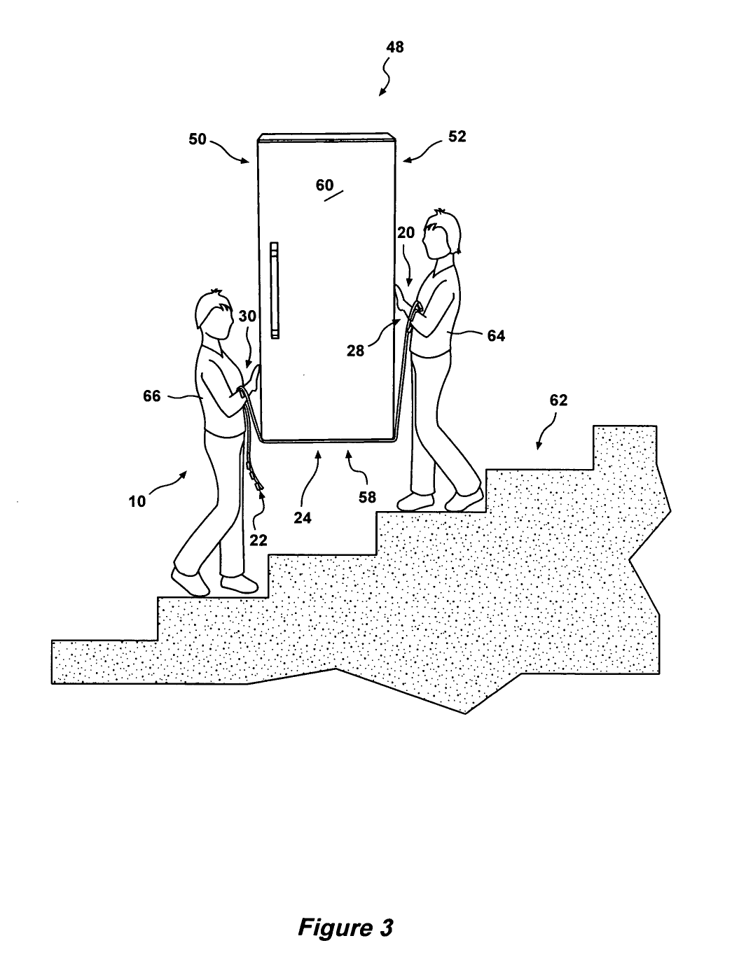

As illustrated in FIGS. 2 and 3 the apparatus 10 is used to manually carry an object such as a refrigerator 48 having side wall 50, 52, a rear wall 54, a top 56, a base 58 and door 60. In use the cross member 58 is positioned under the refrigerator 48 such that the end portions 20, 22 extend out on opposing sides 50 and 52.

In use on a level surface one of the users positions themselves adjacent side 50 and inserts one of their left arms between elongate straps 16 and 18 of support member 12 so that their forearm engages one of the limb engaging band 32, 34, 36. The user can select which limb engaging band is appropriate depending upon their height. The user's right arm is then inserted between elongate straps 16 and 18 of support member 14 so that their forearm engages one of the limb engaging band 32, 34, 36. The user positioned on the other side 52 of the refrigerator 48 likewise positions their arms so that they engage with selected bands 32, 34, 36 of support members 12 and 14. The users then lift their arms to therefore raise the refrigerator 48 off the ground and in this posture carry it to the required location.

As illustrated in FIG. 3 there are circumstances such as when carrying objects up and down a staircase 62 when the users 64 and 66 will be vertically displaced. To negotiate corners or bends in the staircase the object, which in the present example is a refrigerator 48, is preferably carried in an upright position. User 64 positions their arms to engage with the first set of limb engaging bands 28 of support members 12 and 14, while the second user 66 positioned on the side 50 of the refrigerator positions their arms to engage with the second set of limb engaging bands 30 of support members 12 and 14.

In this way the object can be carried down the stairs in an upright position. It should however be appreciated by the reader that the object may be inclined slightly towards user 64 to ensure that it does not topple down the stair onto user 66.

The free ends 22 of support members 12 and 14 are able to simply hand down from the forearms of user 66 or may be slung across the forearm or shoulder to keep them out of the way.

As the skilled addressee would appreciate the base 58 of the refrigerator is typically not flat and usually includes a metal ridge of lip. The present invention assists in supporting the load on the forearm that makes it easier to carry without digging into the hands of the user 66.

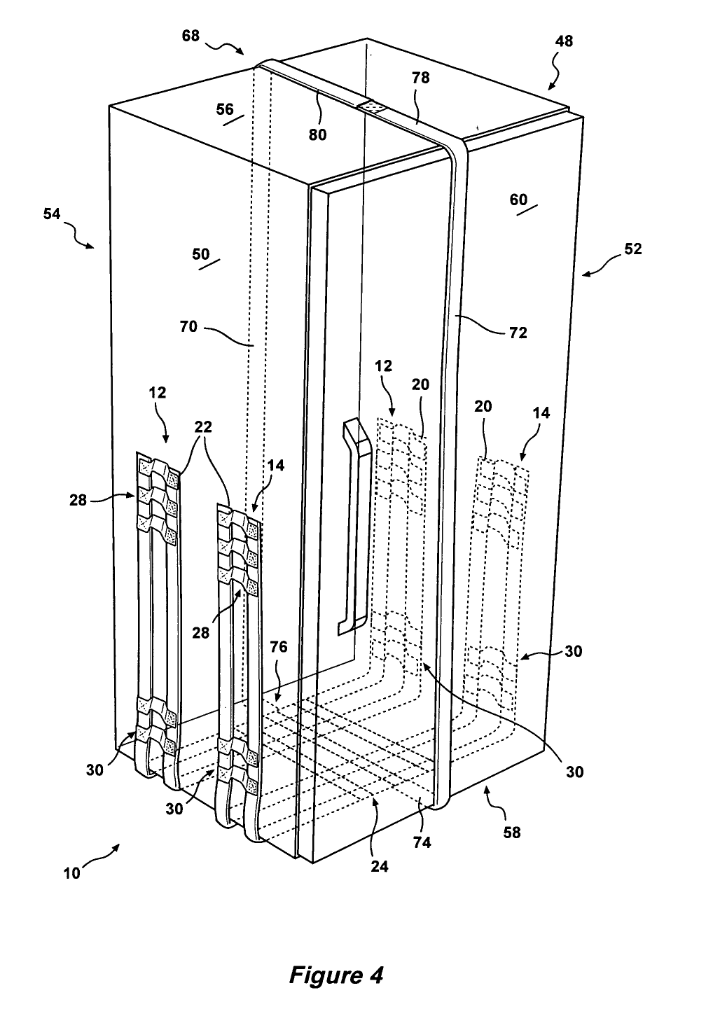

In a second embodiment as illustrated in FIG. 4, the cross member 24 is connected to a securing means 68 for fixing the cross member 24 to the object. In the present embodiment to the securing means 68 includes a first and second portion of strap 70 and 72. One end 74, 76 of each the portions of strap 70, 72 are stitched to the cross member 24 and the free ends 78 and 80 are configured to demountably connect. A fixing means such as hook and loop fastener can be used or alternatively an adjustable clip could be used. The portions of strap 70 and 72 are of a length that they are able to extend up opposing sides and across the top of the refrigerator to fix the cross member 24 to the base 58.

FIG. 3 illustrates a third embodiment, including extended limb engaging bands 82, 84 and 86. The apparatus 10 includes traverse straps 88 that are attached to and extend outwardly from the elongate straps 16, 18 of support members 12, 14.

The traverse straps 88 include engagement means 90 in the form of hook and loop fasteners. The traverse straps 88 are passed around the outside of the fridge and are configured to engage with a corresponding traverse straps 88 on the opposing end of the apparatus to fix the apparatus to the sides of the fridge.

The ends 20 and 22 likewise include engagement means 92 in the form of hook and loop fasteners that are configured to cooperate to hold the ends over the top surface of the fridge. In this way the apparatus 10 is fixedly attached to the fridge. The elongate straps 16, 18 are also held in position as they are stitched to the traverse straps 88. This means that the apparatus 10 acts as fixed webbing against the sides of the fridge.

The extended limb engaging bands 82, 84 and 86 ensures that the users are able to position a portion of a selected band on their forearm during use. It is envisaged that the bands will be constructed from 75-100 mm winch webbing strap and the elongate straps 16, 18 will be constructed from 50 mm seatbelt strap. It should however be appreciated that other materials could be used.

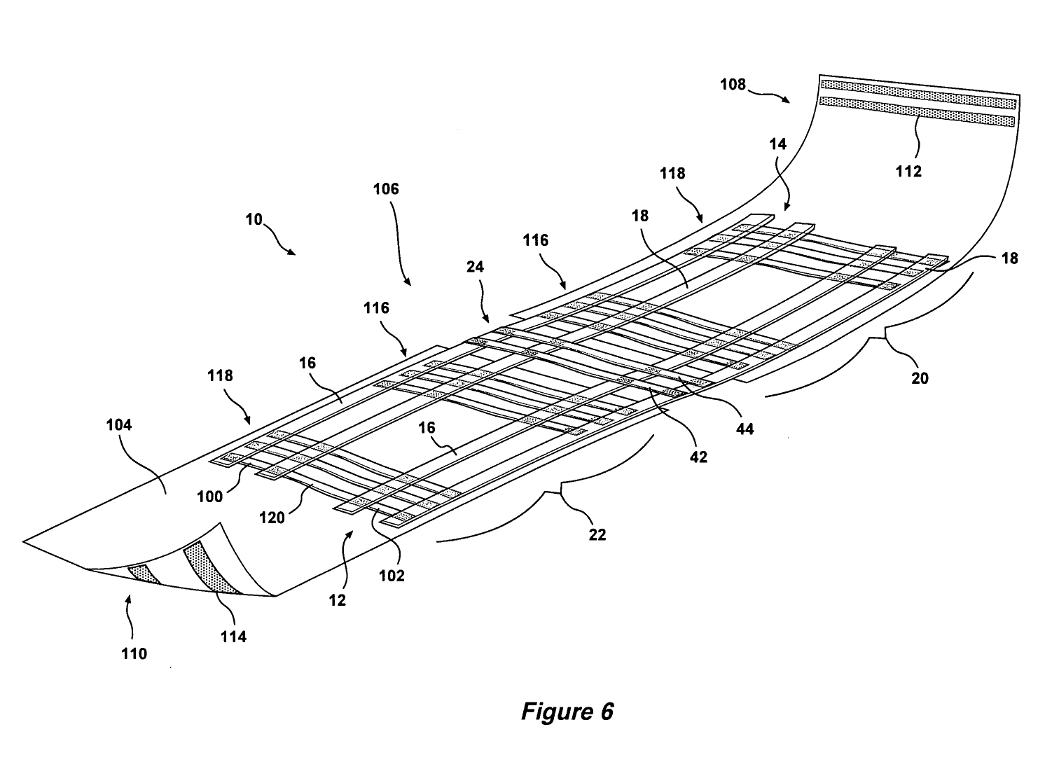

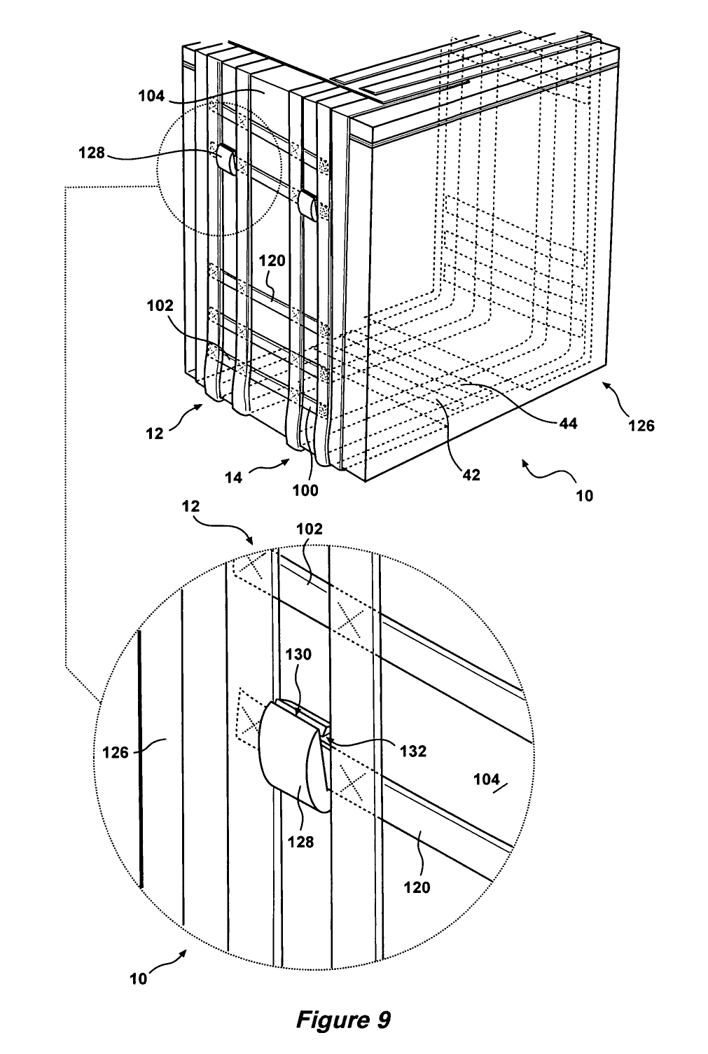

A fourth embodiment is illustrated in FIG. 6 through to FIG. 9 wherein the load carrying apparatus 10 includes, two longitudinally extending support members 12, 14, having respective first and second end portions 20, 22, the first and second end portions 20, 22 include a plurality of graspable handles 100, 102. The support members 12, 14 attached, in a spaced apart configuration, to a generally planar locating means 104, 106, the cross member 26 being positioned under an object to be carried wherein opposing ends 108, 110 of the locating means 104, 106 are secured by way of a cooperating fastening means 112, 114, such that said first and second end portions 20, 22 are held adjacent opposing side of the object.

As illustrated in FIG. 6 the first and second end portions 20, 22 can include respective groups 116, 118 of handles 100, 102. The handles are grouped together along the support members and graspable with either the left or right hands of the users.

The handles 100, 102 can be in the form of straps that are formed by stitching a series of bands 120 between the support members 12, 14 and the generally planar locating means 104.

As illustrated in FIG. 6, there may be two groups of handles, one positioned at the extremity first and second end portions and another group positioned towards the cross member 26 between the locating means 104, 106. In this way the users, who are positioned on opposing sides of the object, can select a handle that enable them to lift and carry the object. It should however be appreciated that move than two groups of handles can be positioned along respective support members. Alternatively, equally spaced handles could be positioned along the entire length of the support members or part thereof.

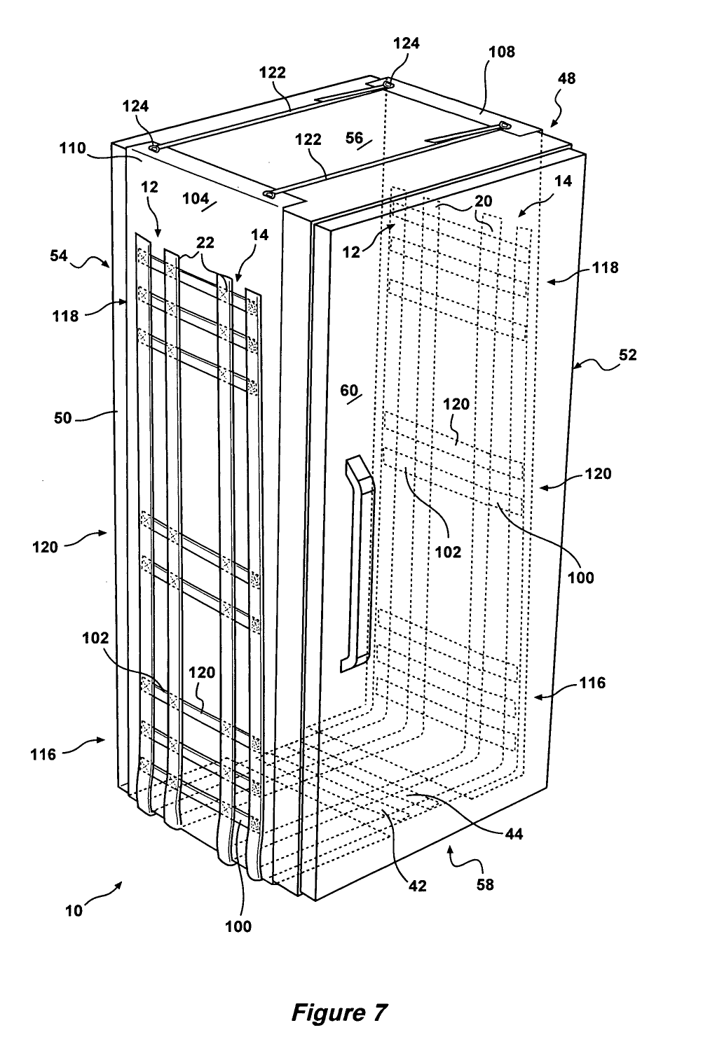

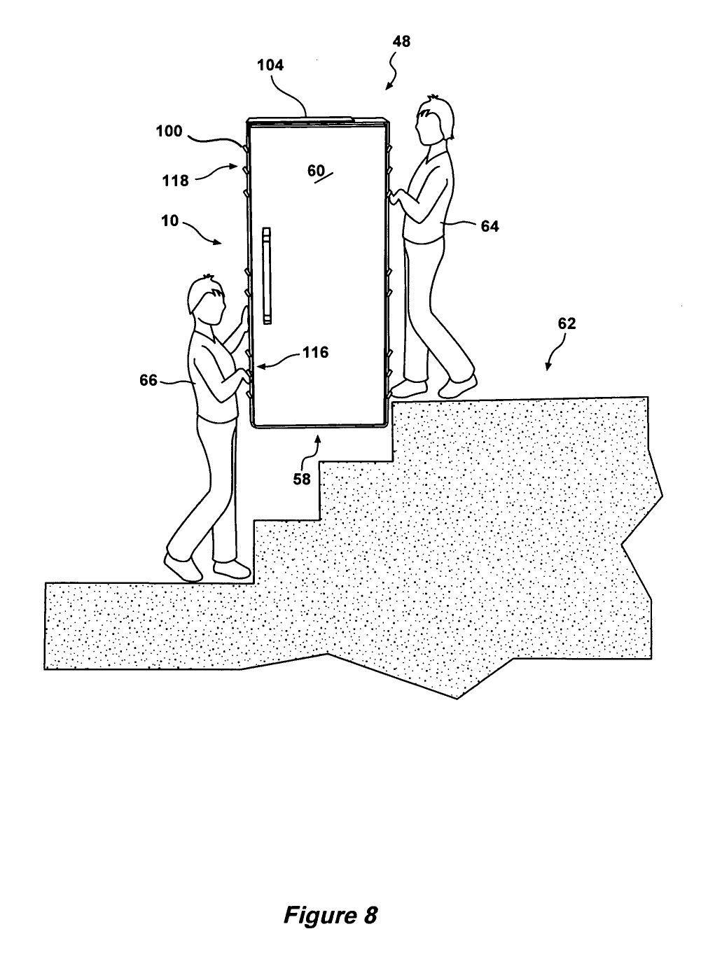

Each group of handles 116, 118 may include three handles, as illustrated in FIG. 6, for each of the right and left hands that are positioned at different heights. FIG. 7 illustrates the use of three groups of handles 116, 118 and 120 wherein the third group includes two handles for respective left and right hands. This means that users of various heights can select a handle that is both suitable for their particular height requirement and for the application, such as flat surface or steps, as illustrated in FIG. 8.

As further illustrated in FIG. 7 the locating means 104, 106 may include a securing means in the form of straps 122 that engage with eyelets 124. In this way the ends of the device 10 can be secured around objects of various sizes without requiring different sized load carrying devices 10. As the reader will appreciate whitegoods, such as fridges, come in a range of different sizes. Accordingly the straps can be simply tightened to compensate for the size of the fridge. As the reader will appreciate the ends of the locating means 104, 106 can overlap and be fastened to each other or alternatively the ends can be secured by way of a plurality of straps. Other fixing means such as clips or hooks could be used to secure the ends.

FIG. 9 illustrates the device 10 attached to a chest freezer 126 and the use of reversibly engagable intermediate pads 128 that can be used to provide cushioning for the hands of the user. These pads 128 may be U-shaped and could be reversible fastened to a selected handle by way of a clip or hook. As illustrated in FIG. 9 the pads 128 has a curved outer surface and a downwardly extending slot 130. The slot 130 includes a depending lip 132 that extends along an upper edge of the slot 130. In this way the user can fit the pad 128 over the handle from the underside of the strap and grasp the pad 128 to lift the object. The pad 128 is prevented from disengaging from the handle by way of the depending lip 132. The user can remove the pad 128 from the handle by manually manipulating the pad to uncouple the depending lip.

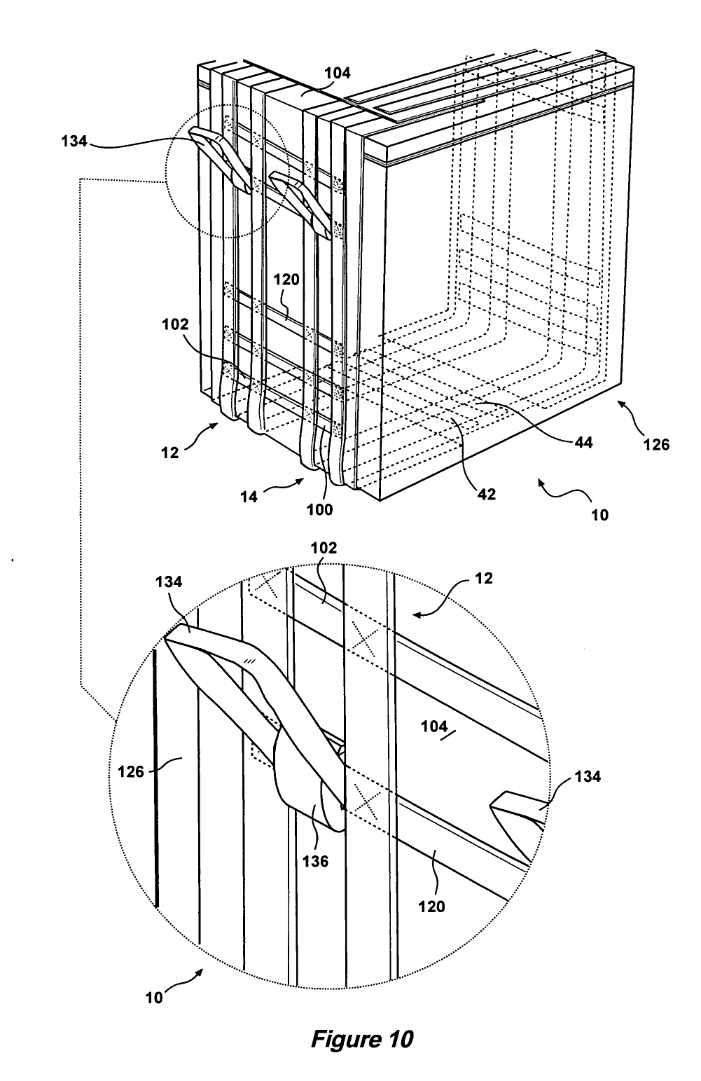

In a further embodiment, as illustrated in FIG. 10, the device 10 includes detachable arm engagement straps 134 connected to a spacer means 136 that can be reversibly coupled to handles 100 or 102. The spacer 136 holds the detachable arm engagement straps 134 in an open configuration so that they are inhibited from pinching the arm of the user during use. As the reader will appreciate the user has the option of grasping the handles 100, 102 with their hands or attaching the arm engagement straps 134 at a height where the user can use their forearm or shoulder to support the article being carried. The user may choose to attach an arm engagement strap 134 to one of handles 100 and grasp one of handles 102 with the hand. In this way the position of the users arms can be at different height that may be useful in manoeuvring heavy or awkwardly shaped items. In the present embodiment the arm engagement straps 134 are removable so they do not get caught on other items during loading of a transport vehicle such as a removalist truck.

The skilled addressee will now appreciate the many advantages of the illustrated invention. In one form the users of the apparatus are able to positions their arms so that they engage with selected limb engaging band to facilitate movement of the object. The apparatus assists the use by supporting some of the weight of the object on the users forearms. This leaves their hands free to grasp or manoeuvre the object. In another form the handles are secured in position by the locating means. The locating means act to both secure the handles in place for easy grasping by the user and to protect the object during transport. In this way the apparatus can be secured to object and left in place during transport of the object in, for instance, a removalist truck.

The apparatus can also be used in situations where the users are vertically displaced, such as when an object is being moved down a flight of stairs. In such a situation the first user is able to positions their arms or hands to engage with selected bands or handles and the second user is able to positioned their arms or hands to engage with the selected bands or handles on the opposite side of the object being carried. The reader will appreciate that in this way the object can be carried down the stairs in an upright position.

Various features of the invention have been particularly shown and described in connection with the exemplified embodiments of the invention, however, it must be understood that these particular arrangements merely illustrate and that the invention is not limited thereto. Accordingly the invention can include various modifications, which fall within the spirit and scope of the invention. For the purpose of the specification the word “comprise” or “comprising” means “including but not limited to”.

1. A load carrying apparatus including, two adjacent support members, said support members having respective first and second end portions and connected, in a spaced apart configuration, at a middle part by a cross member, the cross member being positionable under an object to be carried whereby said end portions extend outwardly from under opposing sides of the object, wherein the first and second end portions including limb engaging bands for engagement with an arm or hand of a user.

2. The load carrying apparatus according to claim 1, wherein secondary limb engaging bands are attached to respective support members at a middle part between, at least, one of the end portions and the cross member, whereby, in use, the load carrying apparatus is suspended between two users to assist in carrying said object in an upright position when the users are vertically displaced.

3. The load carrying apparatus according to claim 1, wherein the support members include a first set of limb engaging bands at respective first and second end portions.

4. The load carrying apparatus according to claim 2, wherein the support members include a second set of limb engaging bands at a middle part between, at least, one of the end portions and the cross member.

5. The load carrying apparatus according to claim 2, wherein the second set of limb engaging bands includes at least two arms engaging bands attached to the support member in a longitudinally spaced apart configuration.

6. The load carrying apparatus according to claim 1, wherein each support member includes two parallel elongate straps, each of the parallel straps being attached to the cross member at a respective middle point.

7. The load carrying apparatus according to claim 1, wherein the first and second set of limb engaging bands are attached to and extend between the two parallel elongate straps of corresponding support members.

8. The load carrying apparatus according to claim 1, wherein the cross member is adjustable such that the distance between the parallel support members can be adjusted.

9. The load carrying apparatus according to claim 1, wherein the cross member is positioned under the object to be carried and includes padding or a wear-resistant surface.

10. The load carrying apparatus according to claim 1, wherein a second set of limb engaging bands may be positioned between the middle part and each end of said support members.

11. The load carrying apparatus according to claim 1, wherein the handles straps, bands and cross member may all be constructed from nylon, polyester or polypropylene strapping.

12. A load carrying apparatus including, two longitudinally extending support members, having respective first and second end portions with a plurality of graspable handles, the support members attached, in a spaced apart configuration, at a middle part, by a cross member, said support members affixed to respective generally planar locating means, the cross member positionable under an object to be carried, whereby opposing ends of said support members extend outwardly from under opposing sides of the object and secured by fastening means connected to the locating means, wherein the respective first and second end portions are held adjacent opposing side of the object.

13. The load carrying apparatus according to claim 12, wherein the handles are grouped together along the support members and graspable with either the left or right hand of a users.

14. The load carrying apparatus according to claim 13, wherein two groups of handles are located along first and second end portions, a first group of handles being positioned at the opposing extremity of the first and second end portions and a second group of handles being positioned towards the middle part of the locating means.

15. The load carrying apparatus according to claim 12, wherein the generally planar locating means may be a sheet of material or webbing, such as but not limited to cotton, felt or polyester.

16. The load carrying apparatus according to claim 12, wherein a user positioned on one side of the object can be vertically displaced from a user positioned on the opposing side of the object such that the users are able to grasp a handles to carry the object down or up an inclined surface, such as a flight of stairs in a generally upright posture.

17. The load carrying apparatus according to claim 13, wherein each group of handles may include three handles for each of the right and left hands that are positioned in a spaced apart configuration, at different heights.

18. The load carrying apparatus according to claim 12, wherein the handles may be in the form of straps that can be grasped by the user.

19. The load carrying apparatus according to claim 12, wherein pads may be provided to reversibly engagable the handles to thereby cushion the hands of the user.

20. The load carrying apparatus according to claim 19, wherein the pads may be U-shaped and could be reversible fastened to a selected handle by way of a clip or hook.

21. The load carrying apparatus according to claim 19, wherein the pads have a curved outer surface and a downwardly extending slot, the slot including a depending lip along an upper surface of the slot.

22. The load carrying apparatus according to claim 21, wherein the user can fit the pad over the handle from the underside of the handle and grasp the pad to lift the object.

23. The load carrying apparatus according to claim 21, wherein the pad is prevented from disengaging with the strap by way of the depending lip.

24. The load carrying apparatus according to claim 12, wherein the locating means is configured to protect the outer surface of the object during transport.

25. The load carrying apparatus according to claim 12, wherein forearm engaging straps can be reversibly attached to said handles.

26. A method of carrying an object with a load carrying apparatus including the steps of:
providing a load carrying apparatus having two adjacent support members having respective first and second end portions and connected in a spaced apart configuration at a middle part by a cross member, the cross member being positioned under an object to be carried such that, in use, the end portions extend outwardly from under opposing sides of the object, each of said first and second end portions including limb engaging bands for engagement with an arm or hand of a user;
positioning a first user on a side of the object, wherein the user engages their arms through or grasps with their hand said limb engaging bands of the first end portion;
positioning a second user on an opposing side of the object, wherein the user engages their arms through, or grasp with their hand said limb engaging bands of the second end portion; and
lifting said object using the load carrying apparatus such that the object can be carried across a surface.
